(19) United States
(12) Patent Application Publication
(10) Pub. No.: US 2014/0300026 A1
(43) Pub. Date: Oct. 9, 2014

(54) BIODEGRADABLE BEVERAGE CARRIER

(71) Applicant: TACCOLINI Raymond, San Juan Capistrano, CA (US)

(72) Inventor: Raymond Taccolini, San Juan Capistrano, CA (US)

(21) Appl. No.: 14/233,146

(22) PCT Filed: Dec. 21, 2012
(86) PCT No.: PCT/US12/71492

§ 371 Date: Jan. 15, 2014

Related U.S. Application Data
(60) Provisional application No. 61/582,158, filed on Dec. 30, 2011.

(51) Int. Cl. B65D 71/52; B29C 41/18

(52) U.S. Cl. CPC B65D 71/0003; B29C 41/18
USPC 264/129

(57) ABSTRACT

A biodegradable liquid container carrier is made from molded pulp or fiber and is designed to grasp liquid containers at the top portion thereof. As a result, less material is used in the manufacture of the carrier. This is made possible by a combination of a wet end treatment with a fatty acid modified PET during processing of the pulp mass before forming the pulp mass into a liquid container carrier. A base coat that is 10-80% clay or pigment, 20-90% styrene-butadiene latex and 0-15% fatty acid modified PET and a top coat that is 75-100% fatty acid modified PET and 0-25% clay mixture onto the base coat are then applied to the molded liquid container carrier. These treatments greatly enhance the strength, rigidity and water-resistance of the carrier. However, the carrier is still biodegradable and will biodegrade in 90 days under composting conditions.

### CROSS-REFERENCE TO RELATED APPLICATIONS

This application claims the benefit of U.S. Provisional Patent Application Ser. No. 61/582,158, filed Dec. 30, 2011, which is incorporated herein by reference in its entirety.

### FIELD

The present application relates to beverage carriers, and more specifically, to a method of preparing a beverage carrier made from biodegradable materials.

### BACKGROUND

Beverage carriers are typically composed of cardboard or plastic. The cardboard carriers tend to lose stability and rigidity, making them ill suited for carrying beverage containers.

Specifically, most cardboard beverage carriers are arranged to support the beverage container at the bottom of the container, whether the beverage container is a can, bottle or cup.

In many cases, the cardboard beverage container is an enclosed box or a carton which may include a base, sidewalls and at least one handle, arranged such that the bottom portion or base of the beverage container rests on the base of the box or carton. As will be appreciated by one of skill in the art, a considerable amount of material is required for the manufacture of this type of beverage carrier.

Also known in the art are cardboard beverage carriers made of molded fiber, for example, a tray having molded sockets for holding the base of a beverage container. However, these trays often lose rigidity or ‘soften’, resulting in the beverage containers tipping over or otherwise falling out of the beverage carrier.

Also known in the art are plastic beverage carriers arranged to grab or grasp the top portion of a beverage container. These beverage carriers typically do not lose integrity or rigidity as quickly as cardboard beverage containers. However, plastic beverage carriers have a different problem—they do not break down or degrade or biodegrade in the environment and can pose a significant risk to aquatic wildlife (particularly the ‘multiple ring’ plastic beverage holders), as has been well documented in the media.

Furthermore, there is a trend towards sustainable packaging which is intended to reduce the environmental impact and ecological footprint of packaging for consumer goods. In general, this trend promotes the use of minimal materials, for example, reduced packaging, reduced layers of packaging, lower mass of packaging, lower volume of packaging and the like. The packaging materials should also be recycled or recyclable or biodegradable as well as non-toxic to humans and/or the environment.

The use of less material in manufacturing of packaging, even biodegradable packaging is also of increasing importance for many retailers, including many large retailers. There is an ever increasing pressure to become ‘green’, with many large chains committed to finding ways to reduce or even eliminate waste.

Clearly, a cardboard or molded fiber beverage container which grasps or grabs beverage or liquid containers at a top portion thereof so that less material is used in manufacture and is biodegradable but maintains integrity and rigidity in use is needed.

### SUMMARY OF THE INVENTION

According to a first aspect of the invention, there is provided a method of providing a biodegradable liquid container carrier comprising:

adding a fatty acid modified polyethyleneterephthalate (PET) and suitable paper sizing chemicals to a quantity of processed pulp to produce a treated pulp;

forming the treated pulp into a liquid container carrier, said liquid container carrier having a plurality of openings, each of said openings being arranged to grip a liquid container at a top portion thereof;

spraying a base coat onto an outer surface of the liquid container carrier, said base coat being selected from the group consisting of comprising 10-80% clay or pigment, 20-90% styrene-butadiene latex and 0-15% fatty acid modified PET;

spraying a top coat comprising 75-100% fatty acid modified PET and 0-25% clay mixture onto the base coat;

inserting a respective one of said liquid containers into a corresponding respective one of said openings;

transporting said liquid container carrier;

removing said respective ones of the liquid containers until the liquid container carrier is empty; and

discarding the liquid carrier container such that the liquid carrier container is subjected to recovery conditions.

The fatty acid PET added to the processed pulp may be modified by any suitable fatty acid or fatty acid source, for example, tall oil, stearic or other suitable heavy or long-chain fatty acids. As discussed herein, the PET is chemically modified so that it is dispersible in water and when used with standard paper sizing agents known in the art such as alkyl ketene dimmer (AKD) or alkyl succinic anhydride (ASA) when the fiber or pulp slurry is being prepared will provide enhanced non-wicking properties to paper or fiber treated with the combined materials.

Specifically, if, following formation of the molded article, the article absorbs water, the article will collapse. Typically, in the art, the article would be coated with wax which would prevent the article from being recycled. The addition of standard paper sizing agents provides the molded article with some water repellency; however, the addition of the fatty acid modified PET, for example, a tall oil modified PET, prevents the wicking of water and therefore an article which is much more water repellent and water resistant. It is of note that this is taught against in the art as most manufacturers of molded articles require a finished article which can absorb water in order for glue to adhere to the finished article.

As discussed herein, the base coat may instead be 20-70% clay, 30-80% styrene-butadiene or styrene-acrylic and 8-11% fatty acid modified PET. Preferably, the fatty acid is tall oil. As will be appreciated by one of skill in the art, the tall oil modified PET is less water-repellent than the stearic acid modified PET and as such permits the top coat to be applied.

As discussed above, the top coat may be 0-25% clay and 75-100% stearic acid modified PET. Preferably, the top coat comprises 10-20% clay and 80-90% stearic acid modified PET. As will be appreciated by one of skill in the art, the amount of clay and stearic acid modified PET used in the top coat will depend on the intended use of the end product. For example, in embodiments in which maximum water repellency is desirable or necessary, the top coat may comprise 100% PET. In other embodiments, in which water repellency is less of a concern and cost is a more important factor, up to 20% clay may be used in the top coat.

According to another aspect of the invention, there is provided a method of providing a biodegradable liquid container carrier comprising: forming processed pulp into a liquid container carrier, said liquid container carrier having a plurality of openings, each of said openings being arranged to grip a liquid container at a top portion thereof; spraying a base coat onto an outer surface of the liquid container carrier, said base coat being selected from the group consisting of comprising 10-80% clay or pigment, 20-90% styrene-butadiene latex and 0-15% fatty acid modified PET; spraying a top coat comprising 75-100% fatty acid modified PET and 0-25% clay mixture onto the base coat; inserting a respective one of said liquid containers into a corresponding respective one of said openings; transporting said liquid container carrier; removing said respective ones of the liquid containers until the liquid container carrier is empty; and discarding the liquid carrier container such that the liquid carrier container is subjected to recovery conditions.

According to a further aspect of the invention, there is provided a method of manufacturing a biodegradable liquid container carrier comprising

adding a fatty acid modified polyethyleneterephthalate (PET) and suitable paper sizing chemicals to a quantity of processed pulp to produce a treated pulp;

forming the treated pulp into a liquid container carrier, said liquid container carrier having a plurality of openings, each of said openings being arranged to grip a liquid container at a top portion thereof;

spraying a base coat onto an outer surface of the liquid container carrier, said base coat being selected from the group consisting of comprising 10-80% clay or pigment, 20-90% styrene-butadiene latex and 0-15% fatty acid modified PET;

spraying a top coat comprising 75-100% fatty acid modified PET and 0-25% clay mixture onto the base coat;

characterized in that said liquid container carrier is stable for greater than 180 days at ambient temperature and 0-70% moisture; stable for greater than 120 days at ambient temperature and 70-100% moisture; and biodegrades over 90 days under composting conditions.

The fatty acid PET added to the processed pulp may be modified by any suitable fatty acid or fatty acid source, for example, tall oil, stearic or other suitable heavy or long-chain fatty acids. As discussed herein, the PET is chemically modified so that it is dispersible in water and when used with standard paper sizing agents known in the art such as AKD or ASA when the fiber or pulp slurry is being prepared will provide enhanced non-wicking properties to paper or fiber treated with the combined materials.

Specifically, if, following formation of the molded article, the article absorbs water, the article will collapse. Typically, in the art, the article would be coated with wax which would prevent the article from being recycled. The addition of standard paper sizing agents provides the molded article with some water repellency; however, the addition of the fatty acid modified PET, for example, a tall oil modified PET, prevents the wicking of water and therefore an article which is much more water repellent and water resistant. It is of note that this is taught against in the art as most manufacturers of molded articles require a finished article which can absorb water in order for glue to adhere to the finished article.

As discussed herein, the base coat may instead be 20-70% clay, 30-80% styrene-butadiene or styrene-acrylic and 8-11% fatty acid modified PET. Preferably, the fatty acid is tall oil. As will be appreciated by one of skill in the art, the tall oil modified PET is less water-repellent than the stearic acid modified PET and as such permits the top coat to be applied.

As discussed above, the top coat may be 0-25% clay and 75-100% stearic acid modified PET. Preferably, the top coat comprises 10-20% clay and 80-90% stearic acid modified PET.

According to another aspect of the invention, there is provided a method of manufacturing a biodegradable liquid container carrier comprising forming processed pulp into a liquid container carrier, said liquid container carrier having a plurality of openings, each of said openings being arranged to grip a liquid container at a top portion thereof; spraying a base coat onto an outer surface of the liquid container carrier, said base coat being selected from the group consisting of comprising 10-80% clay or pigment, 20-90% styrene-butadiene latex and 0-15% fatty acid modified PET; spraying a top coat comprising 75-100% fatty acid modified PET and 0-25% clay mixture onto the base coat; characterized in that said liquid container carrier is stable for greater than 180 days at ambient temperature and 0-70% moisture; stable for greater than 120 days at ambient temperature and 70-100% moisture; and biodegrades over 90 days under composting conditions.

### BRIEF DESCRIPTION OF THE DRAWINGS

The present application can be best understood by reference to the following description taken in conjunction with the accompanying drawing figures, in which like parts may be referred to by like numerals:

FIGS. 1A-1C depict exemplary embodiments of the biodegradable beverage container in a 4-pack, 6-pack and 12-pack configuration, respectively.

### DETAILED DESCRIPTION

The following description sets forth numerous specific configurations, parameters, and the like. It should be recognized, however, that such description is not intended as a limitation on the scope of the present disclosure, but is instead provided as a description of exemplary embodiments.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

A biodegradable liquid container carrier is made from molded pulp or fiber and is designed to grasp liquid containers at a top portion thereof. As a result, less material is used in the manufacture of the carrier.

In some embodiments, the pulp mass is formed into a molded article for example the biodegradable liquid container carrier and a base coat comprising a mixture of clay and either styrene-butadiene or styrene acrylic is applied followed by a top coat comprising either a fatty acid modified PET or a mixture of a fatty acid modified PET and clay.

In some embodiments, the base coat includes a fatty acid modified PET. The fatty acid is preferably tall oil.

In some embodiments the base coat is 10-80% clay and 20-90% styrene-acrylic or styrene butadiene and 0-15% fatty acid modified PET. In other embodiments, the clay may be 20-70% of the base coat; the styrene-acrylic or styrene-butadiene may be 30-80% of the base coat; and the tall oil modified PET may be 8-11% of the base coat.

In some embodiments, the top coat is 75-100% fatty acid modified PET and 0-25% clay, as discussed herein. The fatty acid modified PET may be stearic acid modified PET. As will be appreciated by one of skill in the art, the amount of clay and stearic acid modified PET used in the top coat will depend on the intended use of the end product. For example, in embodiments in which maximum water repellency is desirable or necessary, the top coat may comprise 100% stearic acid modified PET. In other embodiments, in which water repellency is less of a concern and cost is a more important factor, up to 20% clay may be used in the top coat. In preferred embodiments, the top coat comprises 10-20% clay and 80-90% stearic acid modified PET.

In other embodiments, the pulp mass is treated with a ‘wet end’ treatment prior to being formed into the biodegradable liquid container carrier in which a fatty acid modified PET, for example, tall oil modified PET and suitable paper sizing agents known in the art are added.

Tall oil modified PET has lower water repellency than stearic acid modified PET. As a consequence, the use of tall oil modified PET in the base coat allows the stearic acid modified PET top coat to be applied. The tall oil is also more suitable in the wet end treatment. As discussed herein, the wet end treatment improves the water repellency and prevents water wicking in the molded liquid container carrier. This in turn makes the molded product more resistant to the absorption of water which would lead to the product collapsing.

In those embodiments in which the base coat includes a fatty acid modified PET, this promotes greater compatibility with the top coat and makes the top coat more effective, as discussed herein.

These treatments greatly enhance the strength, rigidity and water-resistance of the carrier. However, the carrier is still biodegradable and will biodegrade in 90 days under normal commercial composting conditions.

As used herein, ‘repulpable’ refers to a paper substrate that, when broken down in water, should turn or separate into fiber, with anything else being contaminants. According to a test designed by the Fibre Box Association, when the paper substrate is repulped or broken down in water in the normal recycled paper making process, at least 80% of the weight of the starting sheet has to be recovered in order for the coated paper to be considered repulpable. The balance is typically the film with fiber attached to it or wax both of which can be used as a coating. In the case of a wax coating in addition to possibly not recovering sufficient fiber, the wax will deposit on the paper making equipment or cause spots on the paper made from the repulped fiber. It is of note that biodegradable liquid container carriers made in accordance with the invention is ‘repulpable’ in that the fiber treated with the wet end process described herein will generate greater than 95% fiber.

As used herein, ‘recyclable’ is used as it is generally understood in the art. For example, to be labelled ‘recyclable’, when fiber from a repulping test is used to make paper, the resulting paper product must have the same properties as a paper product that did not have any coating on it. The test used by the Fibre Box Association mixes 20% of fiber from the coated paper with 80% virgin fiber for this test. Appearance and four physical properties are measured on the resulting paper; only small deviations are allowed in the test results when this mixed paper is compared to a sheet generated from 100% virgin fiber.

As will be appreciated by one of skill in the art, “repulpable” generally means that there will be >80% fiber yield; “recyclable” generally means that the paper made from coated paper will have the same properties as if no coated paper was used.

As used herein, the term ‘biodegradable’ is used as generally accepted in the art. For example, to be rated biodegradable, packaging material has to biodegrade under controlled conditions within a specified time. According to accepted standards, biodegradability testing is run under composting conditions, wherein the packaging material is mixed with compost and the combination is evaluated to determine when the packaging material breaks down. The preferred time is 90 days, though it is acceptable to extend the testing for an additional 90 days. Typically, paper by itself has no problem passing this protocol. However, the materials coated or extruded onto the paper can prevent the package from fully biodegrading.

As discussed above, the term ‘compostable’ is sometimes used interchangeably with ‘biodegradable’. The initial testing for this property requires that the structure or coating meets the disintegration requirement for biodegradability, does not contain certain toxic metals and for example does not impede the growth of cress and barley seeds.

The invention relates to a beverage carrier made preferably of molded pulp or molded fiber, or similar moldable, rigid, recyclable and/or biodegradable materials for transporting beverage or liquid containers in any suitably sized containers. More specifically, the invention relates to a recyclable beverage carrier which maintains rigidity and structural integrity under low moisture conditions but biodegrades under commercial composting conditions.

In one aspect of the invention, there is provided a method of biodegrading a liquid container carrier comprising: adding to a quantity of a base polyester polymer that is chemically modified so that it is dispersible in water to produce a treated pulp, forming the treated pulp into a liquid container carrier, said liquid container carrier having a plurality of openings, each of said openings being arranged to grip a liquid container at a top portion thereof; spraying a base coat comprising 10-80% clay or pigment, 20-90% styrene-butadiene or styrene-acrylic latex and 0-15% fatty acid modified PET onto an outer surface of the liquid container carrier; spraying a top coat comprising either a fatty acid modified polyethyleneterephthalate or a mixture of a fatty acid modified PET and clay onto the base coat; inserting a respective one of said liquid containers into a corresponding respective one of said openings; transporting said liquid container carrier; removing said respective ones of the liquid containers until the liquid container carrier is empty; and discarding the liquid carrier container such that the liquid carrier container is subjected to recovery conditions.

As will be readily apparent to one of skill in the art, the term ‘pulp mass’ refers to both paper pulp and fiber pulp. As discussed above, biodegradable liquid container carriers made in accordance with the invention is ‘repulpable’ in that the fiber treated with the wet end process described herein will generate greater than 95% fiber.

As discussed below, the fatty acid modified PET is added at approximately 8-12 dry pounds per ton of the pulp mass. As discussed herein, the wet end PET is preferably modified with tall oil so that it is dispersible in water and when used with standard paper sizing agents, will provide enhanced non-wicking properties to paper or fiber treated in this manner, as discussed herein.

As discussed herein, the base coat and the top coat are applied at approximately 0.3-10% (w)/(w) of the finished product, or such that the outer surface of the biodegradable liquid container carrier is substantially coated with the base coat and the top coat.

0modified PET.

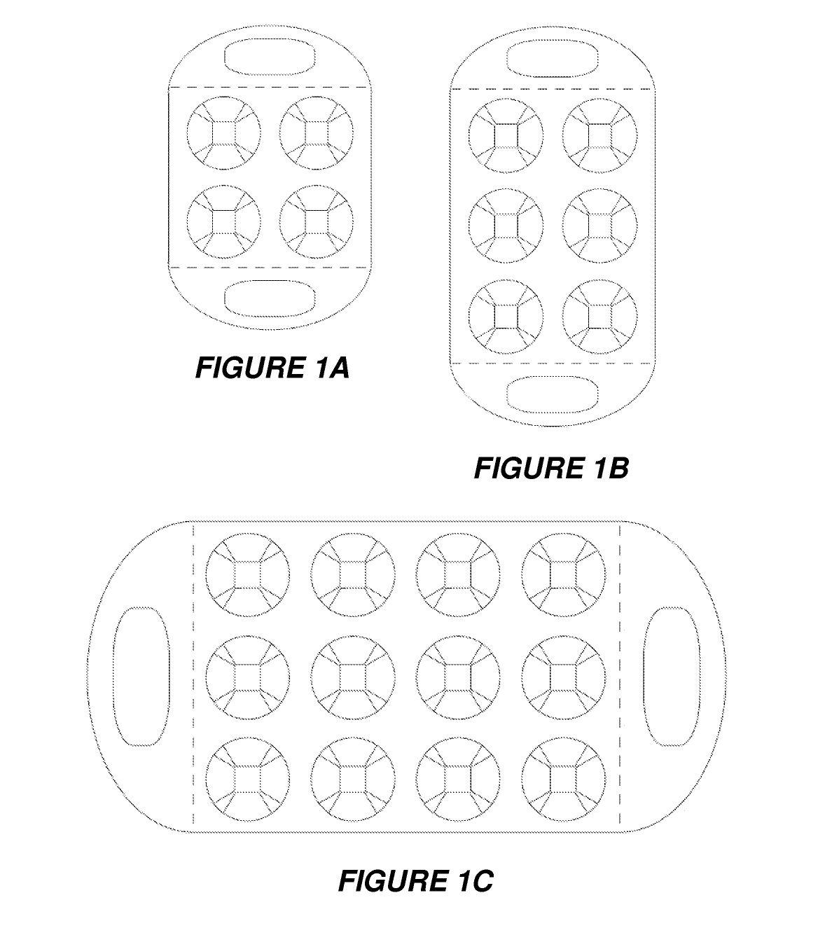

Exemplary embodiments of the biodegradable liquid container carrier are shown in FIGS. 1A-1C. As can be seen therein, there are a plurality of openings, each positioned relative to one another so that liquid containers for example beverage containers can engage a respective opening such that the liquid container is gripped and retained by the rim of the respective opening, thereby securing the liquid container within the liquid container carrier.

As discussed herein, there are a wide variety of sizes and shapes of liquid containers known in the art. Accordingly, the biodegradable liquid container carrier has a corresponding number of different suitable shapes. Specifically, different versions of the biodegradable liquid container carrier are available, depending on the size and shape of the liquid container to be transported as well as on the typical number of a specific liquid container to be transported together. As will be appreciated by one of skill in the art, the shapes and sizes of the openings may vary, depending on the size and shape of the top portions of the liquid containers to be gripped or engaged. For example, smaller openings would be needed to grip the neck of a bottle while larger openings may be needed to grip a can. The spacing between the openings may also be varied such that there is separation between the respective liquid containers being carried. Similarly, the number of openings may be any suitable integer.

It should be understood that the biodegradable liquid container carrier has a substantially flat profile. As a result of this arrangement, less material is used in the manufacture of the carrier than a comparable carrier arranged to support or carry liquid container from or by their base.

It is of note that the biodegradable liquid container carrier may be transported multiple times prior to the removal of any containers. For example, the containers may be inserted into the carrier at a first location and then transported to a second location for sale. A purchaser may transport the carrier with containers in at least one or all of the openings and then may dispose of the biodegradable liquid container carrier appropriately, as discussed herein. Alternatively, purchasers may remove containers from the carrier as required and the biodegradable liquid container carrier may be disposed of at the point of sale.

As used herein, ‘recovery conditions’ refer to conditions under which the biodegradable liquid container carrier is not stable, for example, composting conditions as described herein, repulping or recycling conditions, or exposed to high moisture for an extended period of time, as described herein.

In another aspect of the invention, there is provided a method of manufacturing a biodegradable liquid container carrier comprising adding to a quantity of processed pulp with a base polyester polymer that is chemically modified so that it is dispersible in water to produce a treated pulp; forming the treated pulp into a liquid container carrier, said liquid container carrier having a plurality of openings, each of said openings being arranged to grip a liquid container at a top portion thereof; spraying a base coat as described above onto an outer surface of the liquid container carrier; and spraying a top coat as described above onto the base coat; characterized in that said liquid container carrier is stable for greater than 180 days at ambient temperature and 0-70% moisture; stable for greater than 120 days at ambient temperature and 70-100% moisture; and biodegrades over 90 days under composting conditions.

Molded pulp or molded fiber generally refers to for example fibers for example, wood fiber, bagasse, wool, hemp, cotton, bamboo and the like as discussed herein and/or recycled paper, paperboard cardboard and/or newsprint.

As will be apparent to one of skill in the art, several types of molded pulp products can be manufactured by several different processes known in the art.

For example, “thick wall” or “slush molded” refers to products having a thickness of 3/16 of an inch ( 3/16″) to ½ an inch (½″).

“Transfer molded” refers to products which are thin walled, typically 1/16″ to 3/16″. The process typically uses vacuum forming and take-off or transfer molds, where the mold is an extremely fine wire mesh in the shape of the upper/exposed surface. A fibrous slurry can be sprayed from below onto the mold, and the vacuum draws the slurry tightly against the mesh, filling all gaps and spaces.

“Thermoformed fiber” uses a ‘cure-in-the-mold’ process which produces well defined, smooth surfaced molded articles. After being formed, the product is captured in heating forming molds which presses and densifies the molded products.

The fiber or pulp used in the manufacture of the biodegradable beverage or liquid carrier may be of any suitable source, as discussed above. It is noted that any of the suitable methods discussed above may be used for the formation and production of the biodegradable beverage or liquid carrier.

As discussed herein, the biodegradable carrier is largely intended for the transportation of multiple units of a beverage or liquid container. As will be appreciated by one of skill in the art, any suitable beverage or liquid container may be transported using the container carrier described herein. These include for example one litre plastic bottles, two litre plastic bottles, 591 ml plastic bottles, 12 ounce glass or plastic bottles, 300 ml aluminum cans, 40 ounce aluminum cans and the like. The container carrier described herein may also be used to transport other liquid containers, for example, detergent bottles, canned food, personal care products and the like.

Accordingly, depending on the size or shape of the unit liquid or beverage containers to be transported using the biodegradable beverage or liquid carrier of the instant invention, the biodegradable beverage or liquid carrier may have a variety of different shapes, with the common feature being that in all cases, the biodegradable beverage or liquid carrier is arranged to grip or retain the unit beverage containers from the top or top portion thereof so that, as discussed above, less material is used in the manufacture of the biodegradable beverage or liquid carrier compared to a carrier which supports beverage or liquid containers from their base. For example, the liquid container carrier may include a plurality of openings, each opening being arranged to grip a liquid container at a top portion thereof, as discussed herein.

In some embodiments, the molded pulp or fiber pulp mass is prepared by means known in the art but is mixed with a plurality of chemicals, as discussed below, as part of a ‘wet end’ treatment. This treatment improves the strength of the end product and also prevents wicking of water or other liquids by the end product. As a result, the end product retains strength and rigidity for longer than a comparable untreated carrier.

In other embodiments, the molded pulp or molded fiber beverage or liquid carrier is prepared generally following means known in the art. The finished article is then coated with a base coat, as discussed below, and a top coat comprising a chemically modified polyethyleneterephthalate (PET), for example, a fatty acid modified PET, preferably, tall oil modified PET or stearic acid modified PET. As discussed herein, these coatings impart strength and water-resistance to the end product. Specifically, the base coat acts to ‘fill in’ any ‘gaps’ on the outer surface of the molded paper or fiber biodegradable liquid container carrier and is effectively absorbed by the outer surface of the carrier. The base coat thus ‘smooths’ the outer surface of the liquid container carrier so that less top coat can be applied, thereby reducing the cost of production.

In yet other embodiments, the molded pulp or molded fiber mass is prepared according to the ‘wet end’ treatment and the product as molded according to means known in the art. The base coat and top coat as described herein are then applied to the ‘finished’ product, thereby producing a biodegradable, compostable beverage or liquid carrier. Specifically, by virtue of the chemicals selected for biodegradable beverage or liquid carrier, once composted, there are no chemicals left in the soil which are harmful to the environment and/or humans.

As discussed in U.S. Pat. No. 5,858,551, the contents of which are incorporated herein by reference for the disclosure on the preparation of the chemically modified PET, the polyester resins described therein have the following general formula:

Iₙ—P-Aₘ

wherein I is the ionic group; n is an integer in the range of 1-3 and defines the number of ionic groups; P is a polyester backbone; A is an aliphatic group; and m is an integer in the range of 3-8 and defines the number of aliphatic groups.

The ionic groups I which are required for water-dispersibility are typically derived from a carboxylic acid group which is introduced into the resin by polyacid monomers The weight percent of ionic monomers in the resin is from 1% to 20% percent, with 5 to 10% of ionic monomer being preferred.

The backbone P of the polymer is composed of polyester groups. It can be any linear or branched polyester made using polyacids and polyalcohols. The preferred method is to generate the backbone using polyester from recycled sources. The weight percent of the polyester backbone ingredients range from 30-80% of the whole resin, with the most preferred being 50-60% by weight.

The aliphatic groups A consist of straight or branched 6-24 carbon chain fatty acids or triglycerides thereof. The weight percent of the aliphatic moiety can be 10-60% with 20-40% by weight being the preferred amount.

The backbone of the polymer is composed of polyester groups. It can be any linear or branched polyester made using polyacids and polyalcohols. The preferred method is to generate the backbone using polyester from recycled sources. The weight percent of the polyester backbone ingredients range from 30-80% of the whole resin, with the most preferred being 50-60%. Such backbone is typically derived by reacting PET such as waste PET with a hydroxy functional compound containing at least two hydroxyl groups. The hydroxy functional compound having at least two hydroxy groups is selected from the group consisting of ethylene glycol, diethylene glycol, triethylene glycol, cyclohexanedimethanol, propylene glycol, 1,2-propylene glycol, 1,3-propane diol, 1,2-butylene glycol, 1,3-butanediol, 1,4-butanediol, neopentyl glycol, 1,5-pentanediol, 1,6-hexanediol, glycerol, trimethylolpropane, trimethylolethane, pentaerythritol, erythritol or a monosaccharide. In another embodiment, other hydroxy compounds having at least two hydroxyl groups include derivatives of glycerol, trimethylolpropane, trimethylolethane, pentaeythritol, erythirtol or a monosaccharide oxyalkylated with 5-30 moles of ethylene oxide, propylene oxide or a mixture thereof, per hydroxyl of the hydroxy functional compound.

The aliphatic groups consist of 6-24 carbon chain fatty acids or triglycerides thereof such as stearic, oleic, palmitic, lauric, linoleic, linolenic, behenic acid or their mixtures. These can come from hydrogenated or unhydrogenated animal or vegetable oil, such as beef tallow, lard, corn oil, soy bean oil, etc., etc. If highly unsaturated fatty acids or triglycerides are used care must be taken to prevent cross-linking through the unsaturated group. The weight percent of the aliphatic moiety can be 10-60% with 20-40% the preferred amount.

As discussed above, preferably the PET is modified with tall oil or stearic acid, although other suitable fatty acids yielding the desired properties can also be used within the invention.

The top coat formulation can also include an acrylic polymer, preferably a styrene acrylic, or styrene butadiene. The acrylic polymer, preferably a styrene acrylic, is used because it reduces the glass transition temperature (Tg) of the resulting polymer blend. The use of PET provides repulpability and recyclability to the combined polymers which is not achievable with the acrylic by itself. As discussed herein, in a preferred embodiment, the water-dispersible PET and the acrylic polymer are applied together.

In a preferred embodiment, the styrene acrylic is produced by polymerizing 77 to 83 parts by weight of styrene with 13 to 17 parts of methyl methacrylate, 3 to 4 parts of butyl methacrylate, 0.5 to 2.5 parts of methacrylic acid and 0.1 to 0.3 parts of butyl acrylate such that the finished copolymers have a minimum number average molecular weight greater than 100,000 and a level of residual styrene monomer in the polymer not to exceed 0.1 percent by weight.

It is of note that other suitable acrylic polymers may be used within the invention, for example but by no means limited to: acrylics and their copolymers; acrylamide with ethylacrylate and/or styrene and/or methacrylic acid; acrylic acid and the following esters thereof: ethyl, methyl, butyl; acrylate-styrene-methacrylic acid-hydroxyethyl methacrylate copolymers; butyl acrylate-styrene-methacrylic acid-hydroxypropyl methacrylate copolymers; ethyl acrylate-styrene-methacrylic acid copolymers; 2-ethylhexyl acrylate-ethyl acrylate copolymers; 2-ethylhexyl acrylate-methyl methacrylate-acrylic acid copolymers; methacrylic acid and the following esters thereof: butyl, ethyl; methacrylic acid or its ethyl and methyl esters copolymerized with one or more of the following: acrylic acid, ethyl acrylate, methyl acrylate, n-butyl acrylate-styrene-methacrylic acid-hydroxyethyl methacrylate copolymers; styrene polymers made by the polymerization of any combination of styrene or alpha methyl styrene with acrylic acid, methacrylic acid, 2-ethyl hexyl acrylate, methyl methacrylate, and butyl acrylate; and elastomers such as butadiene-acrylonitrile copolymer, butadiene-acrylonitrile-styrene copolymer, and butadiene-styrene copolymer.

As discussed above, the top coat is either a water-dispersible polyethyleneterephthalate or a water-dispersible polyethyleneterephthalate/clay mixture. As discussed above, the PET is fatty acid modified PET. Preferably, the PET is tall oil modified PET or stearic acid modified PET.

As discussed herein, the modified PET/acrylic coating serves as the ‘top coat’. In some embodiments, a base coat is applied to ‘fill’ or ‘smooth’ the cellulosic material. As discussed above, the top coat is typically applied at 0.3-10.0% by weight of the finished product.

In some embodiments, the base coat comprises a styrene-butadiene polymer binder and a modified PET, as discussed below. In other embodiments, the basecoat may include a pigment or clay from 20% to 70% of the total dry weight of the final coating; it includes an styrene butadiene resin of from 80% to 30% of the total dry weight solids; a third component would be a modified PET which would replace up to 20% of the dry pigment or styrene butadiene solids. The formulation may also include biocides, defoamers and other process aids at minimal levels as needed by the specific formulation.

In a preferred embodiment, the base coat is applied to the paper substrate first, thereby filling in any ‘gaps’ or irregularities in the molded product, thereby providing a smooth surface for application of the top coat, as discussed herein. As discussed above, the base coat is typically applied at 0.3-10.0% by weight of the finished product.

As will be appreciated by one of skill in the art, the percentages of base coat and top coat applied will of course depend on the size and shape of the biodegradable liquid container carrier, as well as the desired end properties of the finished article and the intended use.

While other basecoats may be used, the combination of the above-described basecoat and topcoat provides the desired performance. Lack of compatibility would affect the amount of topcoat used, resulting in a higher cost.

Specifically, tests have shown that when kept under composting conditions for 90 days at 58±2° C., greater than approximately 90% of a paper product coated with the base coat and top coat as described above degraded and soil containing the degraded coated paper product permitted germination of cress seeds and barley, indicating that the product was not harmful to the environment following composting.

For the wet end treatment, a base polyester polymer that is chemically modified so that it is dispersible in water is added to the pulping process or to the pulp mass at approximately 8-12 dry pounds per ton. When used with standard paper sizing agents, as discussed above, this polyester will provide enhanced non-wicking properties to paper or fiber treated with the combined materials.

In some embodiments, in which the processed pulp is under acidic conditions, alum is then added followed by a rosin before the material is passed through a selectifier screen and then processed as discussed above.

Alternatively, under neutral or basic conditions, poly aluminum chloride (PAC) is added instead of alum and a setting resin, such as AKD is used.

It is noted that this process is discussed in detail in Published U.S. Patent Application No. 2003/0127210 which is incorporated herein by reference in its entirety, particularly for those sections dealing with the ‘wet end’ treatment.

As discussed herein, the combination of the top coat, base coat and wet end treatment produces a superior biodegradable liquid container carrier or beverage container carrier which better retains shape and rigidity compared to prior art carriers made of molded pulp or fiber. Furthermore, because of the strength and rigidity imparted by the combination of the wet end treatment, base coat and top coat, the biodegradable liquid container carrier is able to be arranged to grasp or grip liquid containers at a top portion thereof, resulting in a liquid container carrier which has a greatly reduced profile compared to those known in the art and requires less material in the construction thereof.

As discussed herein, the biodegradable liquid container carrier is also compostable.

Paper pulp can be produced by any means known in the art. Paper pulp is a fibrous material produced by mechanically or chemically reducing woody plants into a fiber slurry that is treated with chemicals and then converted into paper, sheets or molded products.

For this application only molded pulp or molded fiber is appropriate. As mentioned above the pulp can come from wood sources but also other fibrous materials.

As discussed below, the biodegradable, compostable container carrier, for example, beverage container is stable for greater than 180 days at ambient temperature and 0-70% moisture and stable for greater than 120 days at ambient temperature and 70-100% moisture.

As will be appreciated by one of skill in the art, ‘stable conditions’ refers to conditions under which the beverage container will not decompose, degrade, compost or biodegrade, for example, conditions under which the direct exposure of the beverage container to water or moisture is limited and controlled. Suitable examples include but are by no means limited to in a store cooler, in a home refrigerator, in a transportation vehicle or on display or in storage. As will be appreciated by one of skill in the art, these can be classified as ‘low temperature, high relative humidity conditions’ and ‘ambient temperature, ambient humidity conditions’.

As will be appreciated by one of skill in the art, ‘recovery conditions’ refers to conditions under which the beverage container is exposed to for example pulping conditions, such as hot water and agitation.

Thus, as will be appreciated by one of skill in the art, the combination of the modified PET and the molded fiber or paper pulp produces a biodegradable beverage carrier which has the desired rigidity but is also biodegradable. This is in contrast to beverage carriers that have a wax coating or are composed of PE-laminated paper or board, which makes the underlying material unrecyclable and to beverage containers having other coatings which fail to impart sufficient rigidity to the beverage carrier which results in beverage containers dropping out of the beverage carrier and breaking or otherwise losing their contents.

Exemplary embodiments of the biodegradable beverage carrier are shown in FIGS. 1A-1C. As will be appreciated by one of skill in the art, a number of suitable biodegradable beverage containers may be designed or developed using the material described herein. Specifically, the moisture resistance characteristics produce a product which is sufficiently rigid to stably retain and support the beverage containers by their top portions only (for example, rim or neck), as discussed below, meaning that less material is used in their manufacture. Furthermore, the biodegradable beverage carrier rapidly degrades on exposure to sufficient moisture and bacteria, meaning that the biodegradable beverage carrier poses no hazard to wildlife or the environment.

As can be seen, in the embodiments shown in FIGS. 1A-1C, the biodegradable beverage carrier is arranged to have a functionality similar to that of the plastic ring-based beverage carriers. Specifically, the biodegradable beverage carrier includes a plurality of openings that have segmented sections on the outer perimeter of the openings. In use, beverage containers can be inserted through the openings such that a top portion of the beverage container interacts with one or more of the segmented sections, thereby stably retaining the beverage container within the biodegradable beverage carrier. It is to be understood that as used herein, depending on the nature of the beverage container, ‘top portion’ may be a relative term. For example, beverage containers such as cans have a substantially uniform shape, having a ‘top portion’ which is substantially identical to the ‘bottom portion’. Furthermore, the top portion may comprise a rim when the beverage container is a can or may be a tapered neck when the beverage container is a glass bottle or a plastic bottle.

In the embodiments shown in FIGS. 1A-1C, the biodegradable beverage carrier includes a plurality of openings for stably retaining beverage containers therein and two large slots which serve as handles for carrying the biodegradable beverage carrier during transport of the beverage containers.

During the transportation process, the biodegradable beverage carrier supports the entire weight of the beverage container by engaging the top portion thereof (for example the neck of a bottle or rim of a can) as discussed above while the barrel or lower portion thereof remains exposed.

Once the segmented sections engage the top portion of the beverage container, the beverage container is stably retained within the biodegradable beverage carrier until a user desires to remove the beverage container from the biodegradable beverage carrier. Specifically, the user grasps the desired retained beverage container along its sidewall and pulls downward, causing the beverage container to be released from the segmented sections and for the top portion of the beverage container to pass through the respective opening in a downward direction.

When the biodegradable beverage carrier is empty, it can be discarded for recycling. Alternatively, if the biodegradable beverage container is not collected for recycling but instead is discarded into the environment, the biodegradable beverage carrier will, on contact with sufficient moisture levels and bacteria in the environment as discussed above, begin to degrade. As a result, the biodegradable beverage carrier poses no risk to wildlife or the environment as even when it is improperly disposed of, for example, discarded in a landfill, field or body of water. Furthermore, as discussed above, when disposed of under proper composting conditions, the biodegradable liquid container carrier will biodegrade such that approximately 90% or more of the material is broken down.

While the preferred embodiments of the invention have been described above, it will be recognized and understood that various modifications may be made therein, and the appended claims are intended to cover all such modifications which may fall within the spirit and scope of the invention.

1. A method of providing a biodegradable liquid container carrier comprising:
adding a fatty acid modified polyethyleneterephthalate (PET) and suitable paper sizing chemicals to a quantity of processed pulp to produce a treated pulp;
forming the treated pulp into a liquid container carrier, said liquid container carrier having a plurality of openings, each of said openings being arranged to grip a liquid container at a top portion thereof;
spraying a base coat onto an outer surface of the liquid container carrier, said base coat being selected from the group consisting of comprising 10-80% clay or pigment, 20-90% styrene-butadiene latex and 0-15% fatty acid modified PET;
spraying a top coat comprising 75-100% fatty acid modified PET and 0-25% clay mixture onto the base coat;
inserting a respective one of said liquid containers into a corresponding respective one of said openings;
transporting said liquid container carrier;
removing said respective ones of the liquid containers until the liquid container carrier is empty; and
discarding the liquid carrier container such that the liquid carrier container is subjected to recovery conditions.

2. The method according to claim 1 wherein the suitable paper sizing agents are alkyl ketene dimmer (AKD) or alkyl succinic anhydride (ASA).

3. The method according to claim 1 wherein the fatty acid modified PET added to the processed pulp is a tall oil modified PET.

4. The method according to claim 1 wherein the base coat is 20-70% clay, 30-80% styrene-butadiene or styrene-acrylic and 8-11% fatty acid modified PET.

5. The method according to claim 4 wherein the fatty acid is tall oil.

6. The method according to claim 1 wherein the fatty acid modified PET in the top coat is stearic acid modified PET.

7. The method according to claim 6 wherein the top coat is 10-20% clay and 80-90% stearic acid modified PET.

8. A method of providing a biodegradable liquid container carrier comprising:
forming processed pulp into a liquid container carrier, said liquid container carrier having a plurality of openings, each of said openings being arranged to grip a liquid container at a top portion thereof;
spraying a base coat onto an outer surface of the liquid container carrier, said base coat being selected from the group consisting of comprising 10-80% clay or pigment, 20-90% styrene-butadiene latex and 0-15% fatty acid modified PET;
spraying a top coat comprising 75-100% fatty acid modified PET and 0-25% clay mixture onto the base coat;
inserting a respective one of said liquid containers into a corresponding respective one of said openings;
transporting said liquid container carrier;
removing said respective ones of the liquid containers until the liquid container carrier is empty; and
discarding the liquid carrier container such that the liquid carrier container is subjected to recovery conditions.

9. The method according to claim 8 wherein the base coat is 20-70% clay, 30-80% styrene-butadiene or styrene-acrylic and 8-11% fatty acid modified PET.

10. The method according to claim 9 wherein the fatty acid is tall oil.

11. The method according to claim 8 wherein the fatty acid modified PET in the top coat is stearic acid modified PET.

12. The method according to claim 11 wherein the top coat is 10-20% clay and 80-90% stearic acid modified PET.

13. A method of manufacturing a biodegradable liquid container carrier comprising
adding a fatty acid modified polyethyleneterephthalate (PET) and suitable paper sizing chemicals to a quantity of processed pulp to produce a treated pulp;
forming the treated pulp into a liquid container carrier, said liquid container carrier having a plurality of openings, each of said openings being arranged to grip a liquid container at a top portion thereof;
spraying a base coat onto an outer surface of the liquid container carrier, said base coat being selected from the group consisting of comprising 10-80% clay or pigment, 20-90% styrene-butadiene latex and 0-15% fatty acid modified PET;
spraying a top coat comprising 75-100% fatty acid modified PET and 0-25% clay mixture onto the base coat;
characterized in that said liquid container carrier is stable for greater than 180 days at ambient temperature and 0-70% moisture; stable for greater than 120 days at ambient temperature and 70-100% moisture; and biodegrades over 90 days under composting conditions.

14. The method according to claim 13 wherein the suitable paper sizing agents are AKD or ASA.

15. The method according to claim 13 wherein the fatty acid modified PET added to the processed pulp is a tall oil modified PET.

16. The method according to claim 13 wherein the base coat is 20-70% clay, 30-80% styrene-butadiene or styrene-acrylic and 8-11% fatty acid modified PET.

17. The method according to claim 16 wherein the fatty acid is tall oil.

18. The method according to claim 13 wherein the fatty acid modified PET in the top coat is stearic acid modified PET.

19. The method according to claim 18 wherein the top coat is 10-20% clay and 80-90% stearic acid modified PET.

20. A method of manufacturing a biodegradable liquid container carrier comprising
forming processed pulp into a liquid container carrier, said liquid container carrier having a plurality of openings, each of said openings being arranged to grip a liquid container at a top portion thereof;
spraying a base coat onto an outer surface of the liquid container carrier, said base coat being selected from the group consisting of comprising 10-80% clay or pigment, 20-90% styrene-butadiene latex and 0-15% fatty acid modified PET;
spraying a top coat comprising 75-100% fatty acid modified PET and 0-25% clay mixture onto the base coat;
characterized in that said liquid container carrier is stable for greater than 180 days at ambient temperature and 0-70% moisture; stable for greater than 120 days at ambient temperature and 70-100% moisture; and biodegrades over 90 days under composting conditions.

21. The method according to claim 20 wherein the base coat is 20-70% clay, 30-80% styrene-butadiene or styrene-acrylic and 8-11% fatty acid modified PET.

22. The method according to claim 21 wherein the fatty acid is tall oil.

23. The method according to claim 20 wherein the fatty acid modified PET in the top coat is stearic acid modified PET.

24. The method according to claim 23 wherein the top coat is 10-20% clay and 80-90% stearic acid modified PET.
